(19) United States
(12) Patent Application Publication
(10) Pub. No.: US 2002/0114613 A1
(43) Pub. Date: Aug. 22, 2002

(54) Audio/video editing in digital network recorders

(75) Inventor: Phuoc M. Thai, El Cajon, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Corporation

(21) Appl. No.: 09/785,352

(22) Filed: Feb. 16, 2001

(51) Int. Cl. H04N 5/76

(52) U.S. Cl. 386/52; 386/54

(57) ABSTRACT

A digital network recorder consists of a digital storage device including audio/video editing software and a television signal input, a video input and an audio input each coupled to the digital storage device. Also included is a processor coupled to the digital storage device and a television signal output coupled to the digital storage device. The digital storage device stores television signals from the television signal input, audio signals from the audio input and video signals from the video input. The audio/video editing software integrated into the digital network recorder enables a user to create an audio/video edit file including portions of the television signals and portions of the one or more of the audio signals and the video signals, as well as provided special effects.

### BACKGROUND OF THE INVENTION

1. Field of the Invention

The present invention relates generally to digital network recorders, and more specifically to digital network recorders that are capable of recording and playing live television signals and receive updates from a network. The present invention also relates generally to audio/video editing, and more specifically to the creation of audio/video edit files using audio/video editing software.

2. Discussion of the Related Art

A television video recording unit (also known in the art as a digital hard disk video recorder or a digital network recorder) is a device which inputs a television signal, e.g. a television RF signal, continuously records the television signal and then outputs the television signal having been recorded to a television for the user to view. The input television signal may be received from an antenna system, a cable delivery system, or a satellite receiver, for example. Internally, the television recording unit includes a large hard disk drive for storing the television signal. The recording and playing feature is governed by an operating system stored on the hard drive. The operating system behaves as an operating system on a computer; thus, the digital network recorder combines the functionality of a personal computer (PC) with that of a video cassette recorder (VCR). Further included within the digital network recorder is encoder functionality for digitizing the input television signal (in the case of an analog input television signal), and encoding and compressing the signal for storage on the hard drive. Decoder functionality then decodes and decompresses the stored television signal and provides an output television signal (in either analog or digital format depending on the television type) to the television which is time shifted with respect to the input television signal by a short period of time depending on the speed of the digital network recorder, e.g., typically only a few seconds.

Advantageously, since the live television RF signal is continuously being recorded, the user may actually pause, rewind, or replay the live television signal. The user can simply fast forward back to real time to catch up to the “live” television signal.

### SUMMARY OF THE INVENTION

The present invention advantageously addresses the needs above as well as other needs by providing.

In another embodiment, the invention can be characterized as a digital network recorder including a digital storage device including audio/video editing software and a television signal input, a video input and an audio input each coupled to the digital storage device. Also included is a processor coupled to the digital storage device and a television signal output coupled to the digital storage device. The digital storage device stores television signals from the television signal input, audio signals from the audio input and video signals from the video input.

In a further embodiment, the invention can be characterized as an audio/video editing system including a digital network recorder including audio/video editing software, an input television signal coupled to a first input of the digital network recorder, and a television coupled to a first output of the digital network recorder. The system also includes an external audio/video source coupled to a second input of the digital network recorder and an external memory device coupled to a second output of the digital network recorder.

In an additional embodiment, the invention can be characterized as a method of audio/video editing in a digital network recorder including the steps of: inputting one or more of a recorded audio signal and a recorded video signal from an external recording device into the digital network recorder; digitally storing the one or more of the recorded audio signal and the recorded video signal within the digital network recorder; inputting a live television signal into the digital network recorder; digitally storing the live television signal within the digital network recorder; creating an audio/video edit file including portions of the one or more of the recorded audio signal and the recorded video signal having been stored and portions of the live television signal having been stored; and storing the audio/video edit file within the digital network recorder.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a system level block diagram including a digital network recorder having audio/video editing functionality in accordance with one embodiment of the invention;

FIG. 2 is a block diagram of components of the digital network recorder of FIG. 1 including audio/video editing software according to one embodiment of the invention;

FIG. 3 is a flowchart of the steps performed by the digital network recorder of FIGS. 1 and 2 while utilizing the audio/video editing software; and

FIG. 4 is a diagram of one embodiment of a user interface with the audio/video editing software using a remote control compatible with the digital network recorder.

Corresponding reference characters indicate corresponding components throughout the several views of the drawings.

### DETAILED DESCRIPTION OF THE INVENTION

The following description is not to be taken in a limiting sense, but is made merely for the purpose of describing the general principles of the invention. The scope of the invention should be determined with reference to the claims.

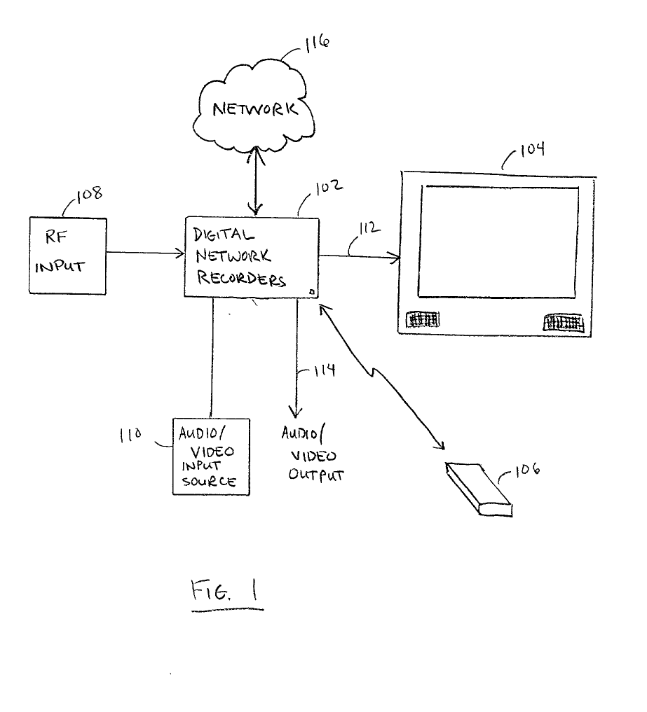

Referring first to FIG. 1, a system 100 is shown including a digital network recorder having audio/video editing functionality in accordance with one embodiment of the invention. Shown is a digital network recorder 102, a television 104, a remote control 106, an input television signal 108 (also referred to as the raw television signal), an input audio/video input source 110, an output television signal 112, an audio/video output 114 and a computer network 116.

The digital network recorder 102 is known in the art as a device which receives an input television signal 108, e.g. a television RF signal, records the television signal 108 and then produces the output television signal 112 which is sent to the television 104. The digital network recorder 102 is also referred to in the art as a network video recorder, a hard disk video recorder, or a digital personal video recorder. An example of such a device is the Sony Digital Network Recorder SVR-2000, commercially available from Sony Electronics Inc., of Park Ridge, N.J., which incorporates TiVO Service (TM) developed by TiVO, Inc. of Sunnyvale, Calif. Another example is the Panasonic PV-HS2000 Showstopper Hard Disk Recorder, commercially available from Matsushita Electronics Corporation of America headquartered in New Jersey, which uses Replay TV Service developed by RePlay TV, Inc., of Mountain View, Calif.

The input television signal 108 may be received from an antenna system, a cable delivery system (e.g. cable modem or a cable set top box), or a satellite receiver, for example, provided by a television service provider. Typically, the input television signal 108 is referred to as an RF input, since television signals are commonly modulated on a radio frequency (RF) carrier. Internally, the digital network recorder 102 includes a large hard disk drive (e.g. a 30 Gbyte hard disk) for storing the input television signal 108. The recording and playing feature is governed by an operating system stored on the hard drive of the digital network recorder 102. The operating system behaves as an operating system on a computer; thus, the digital network recorder 102 combines the functionality of a PC with that of a VCR. For example, the Sony SVR-2000 utilizes a LINUX operating system, while the Panasonic PV-HS2000 utilizes a WINDOWS operating system. Further included within the digital network recorder 102 is encoder functionality for digitizing the input television signal 108 (in the event the input television signal 108 is analog), encoding and compressing the input television signal 108 for storage on the hard drive. By way of example, the input television signal 108 is encoded using the motion picture experts group 2 standard (MPEG2) as known in the art. Decoder functionality then decodes and decompresses the stored data representing the input television signal 108 and provides an output television signal 112 (in either analog or digital format depending on the television type) to the television 104.

Thus, in effect, the digital network recorder 102 buffers the input television signal 108. Advantageously, since the live input television signal 108 is continuously being recorded by the digital network recorder 102, the user may actually pause the output television signal 112, e.g. to answer a telephone or to use the restroom. Similarly, the user may rewind the television broadcast to watch a portion over again, e.g., to see a user created instant replay. The user can simply fast forward back to real time to catch up to the “live” input television signal 108. It is noted that such digital network recorders are known in the art as “time shifting devices” since the output television signal 112 is shifted in time about 1-2 seconds with respect to the input television signal 108 due to the continuous recording of the input television signal 108.

Additionally, the digital network recorder 102 is referred to as a network recorder, since the digital network recorder 102 includes a modem (not shown) for coupling the digital network recorder 102 to a computer network 116, e.g., the Internet. This enables the digital network recorder 102 to receive updates and control information from services in the computer network 116 that manage the digital network recorder 102. For example, the Sony SVR-2000 periodically dials into a TiVo Service server, which downloads programming schedules and other information to the digital network recorder 102. It is noted that this feature is well known and understood in the art.

In accordance with several embodiments of the invention, the digital network recorder 102 includes audio/video editing software capable of allowing a user to create and edit audio and/or video signals. In these embodiments, the digital network recorder 102 includes an input to receive one or more of audio signals and video signals from an external audio/video input source 110. The audio/video input source 110 may be any external device that is capable of recording audio and or video signals, such as a video camera, camcorder, digital camera, CD player, MP3 player, DVD player, a laptop or desktop personal computer, etc. The audio/video input source 110 contains prerecorded audio and/or video signals that are downloaded into the digital network recorder 102 so that a user may create a single audio/video edit file.

Instead of purchasing expensive professional quality audio/video editing stations or requiring that a user own a personal computer having audio/video editing functionality, this functionality is provided within the digital network recorder 102. Advantageously, since such audio/video editing functionality is incorporated into the digital network recorder 102, the user is able to incorporate live television signals that are routinely stored within the digital network recorder 102 into a resulting audio/video edit file that the user creates. The digital network recorder 102 provides all of the audio/video editing functionality, which is stored as software on the hard drive of the digital network recorder 102.

Further advantageously, the user is able to operate the audio/video editing functionality by using the remote control 106 that is provided to operate the digital network recorder 102. For example, the audio/video editing functionality creates user interface displays for display on the television 104 coupled to the digital network recorder 102 to prompt the user to create an audio/video edit file. Again, the user can create this file incorporating portions of previously stored audio and/or video signals that are received into the digital network recorder 102 via the audio/video input source 110 and portions of a live television signal that are stored on the hard drive of the digital network recorder 102 in its normal usage. Furthermore, the audio/video editing software includes the functionality to add other features, e.g., special effects, text and graphics overlays, to enhance the audio/video edit file.

The digital network recorder 102 of this embodiment provides a unique level of integration between audio/video editing equipment that are traditionally designed to edit external prerecorded audio/video signals and between digital network recorders which previously have functioned to record a live television signal for features desirable to a user watching live television, e.g., pausing, rewinding and fast forwarding the live television signal.

Additionally, once an audio/video edit file is created within the digital network recorder 102, this file may be exported to an external device via the audio/video output 114 of the digital network recorder 102. Further details describing the audio/video editing functionality of the digital network recorder 102 are provided below.

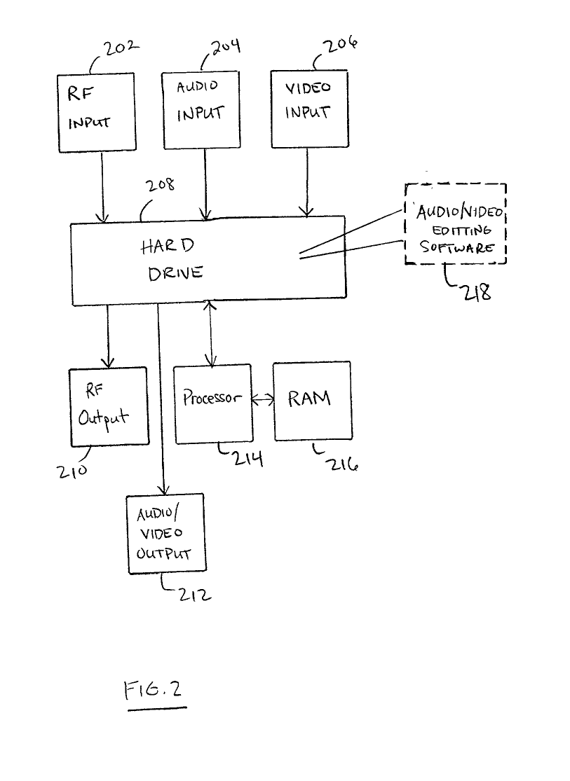

Referring next to FIG. 2, a block diagram is shown of components of the digital network recorder of FIG. 1 including audio/video editing software according to one embodiment of the invention. Shown is a television signal input 202 (also referred to as an RF input), an audio input 204, a video input 206, a hard drive 208 (also referred to generically as a “digital storage device”), a television output 210 (also referred to as an RF output), an audio/video output 212, a processor 214, and a random access memory 216 (hereinafter referred to as RAM 216). Also illustrated is audio/video editing software 218 that is stored on the hard drive 208.

According to several embodiments of the invention, the hard drive 208 includes audio/video editing software 218 which is used to allow a user to edit prerecorded audio and/or video signals received from an external audio/video source and recorded television signals from the television signal input 202. Thus, the digital network recorder includes a television signal input 202 for receiving a live RF television signal. The television signal input 202 is coupled to the hard drive 208. The hard drive 208 includes the operating system and other software to continuously record the incoming television signal and to output the television signal to a television coupled to the television output 210. The incoming television signal is compressed and digitally stored on the hard drive 208. The operation of storing and compressing the incoming television signal is well known in the art.

Furthermore, external audio signals and external video signals may be received into the digital network recorder via the audio input 204 and the video input 206, respectively. This allows for example, an analog or digital camcorder or video recorder to be coupled to the digital network recorder. These signals may be received via RCA connectors, S-video connectors, and PCMCIA ports (for a digital camera), Universal Serial Bus (USB), and IEEE 1394 interfaces (e.g., i.LINK), for example. Furthermore, a digital camera may be coupled to the digital network recorder via the video input 206, since the video input can accept digital picture images the same as accepting digital video images. These inputs are advantageously used to download audio/video content into the digital network recorder and stored digitally on the hard drive 208. It is noted that in one embodiment, the audio input 204 and the video input 206 are a single input that receives audio and/or video signals. Furthermore, in some embodiments, there is a separate digital camera input, e.g., a PCMCIA port.

The audio/video editing software 218 may be similar to any audio/video editing software found within specialized audio/video editing equipment or that is available for personal computers. The audio/video editing software 218 is stored on the hard drive 208 and loaded in to the RAM 216 to be run by the processor 214. For example, the user prompts the digital network recorder to load the audio/video editing software 218 using the remote control provided to operate the digital network recorder. Once the audio/video editing software 218 is loaded and ready, the user is able to edit audio and video content stored on the hard drive 208. Advantageously, the user is able to access audio and video content that is downloaded from the external audio/video source, e.g., digital camcorder, as well as access audio/video content that is recorded from the live television signal that is buffered by the digital network recorder. This is a departure from known audio/video editing stations, which only have the ability to edit audio and video content that is prerecorded using an external recording device and downloaded into the editing station. Such conventional audio/video editing stations do not input unrecorded broadcast television signals, record them and make them accessible to the editor to incorporate with other externally downloaded audio/video content. In contrast, this embodiment provides the audio/video editing software 218 within the digital network recorder such that such downloaded content may be edited with content from a live television signal that is automatically recorded in the normal functionality of the digital network recorder. Additionally, the audio/video editing software 218 is entirely contained within the housing of the digital network recorder; thus, the user does not have to purchase separate audio/video editing equipment. Also, the audio/video editing software 218 can be downloaded into the digital network recorder using the network connection, e.g., modem, or periodically updated with new versions of the audio/video editing software.

The audio/video editing software 218 includes the functionality such that the user will be able to edit content stored on and/or downloaded into the digital network recorder. Such audio video editing features are common to most known video editing stations and software available for personal computers. For example, the user may add special effects, sound effects, video titles and other captions, and add graphics overlays. The audio/video editing software 218 will also provide script or templates to facilitate directing and producing for a total moviemaking experience. Additionally, the user will have the ability to do motion capture to create three-dimensional animation. The user will also be able to enhance, zoom, rotate, replace and overlay on the picture. The audio/video editing software 218 will provide robust, dynamic stages of audio/video editing fit for a beginner to a professional level editor.

Similar audio/video editing software is known and commercially available. For example, such audio/video editing software may be found within video editing stations produced by Applied Magic, Inc. of Carlsbad, Calif., USA, for example, the Applied Magic Screenplay. Although such video editing devices are known, conventional video editing devices do not additionally function as a set top box (STB) that receives television signaling from a television service provider (e.g., via cable or satellite or other) for viewing on a television coupled thereto. Such video editing stations simply perform video editing only and are not capable of receiving normal television programming. In contrast, the digital network recorder of this embodiment functions as set top box and in some cases includes a modem to be coupled to the television provider interface (e.g., cable modem interface). The digital network recorder is also to perform audio/video editing as described herein, all conveniently within a single integrated set top box-style device.

Other examples of specific audio/video editing software include iMAC DV iMOVIE2 produced by and commercially available from Apple Computer, Inc. of Cupertino, Calif., USA; Ulead MediaStudio Pro 6.0 available from Ulead Systems, Inc. of Torrance Calif., USA and of Taipei, Taiwan; and PYRO ProDV using the PYRO 1394 DV card produced and commercially available from ADS Technologies, Inc. of Cerritos, Calif., USA. Similar audio/video editing software is provided for the audio/video editing software 218 of the digital network recorder of several embodiments of the invention.

The audio/video editing software 218 is used to create an audio/video edit file, which is stored on the hard drive 208 of the digital network recorder. This audio/video edit file may be uploaded or exported via the audio/video output 212 to an external storage device, such as an external drive, memory stick, VHS, digital camera, etc.

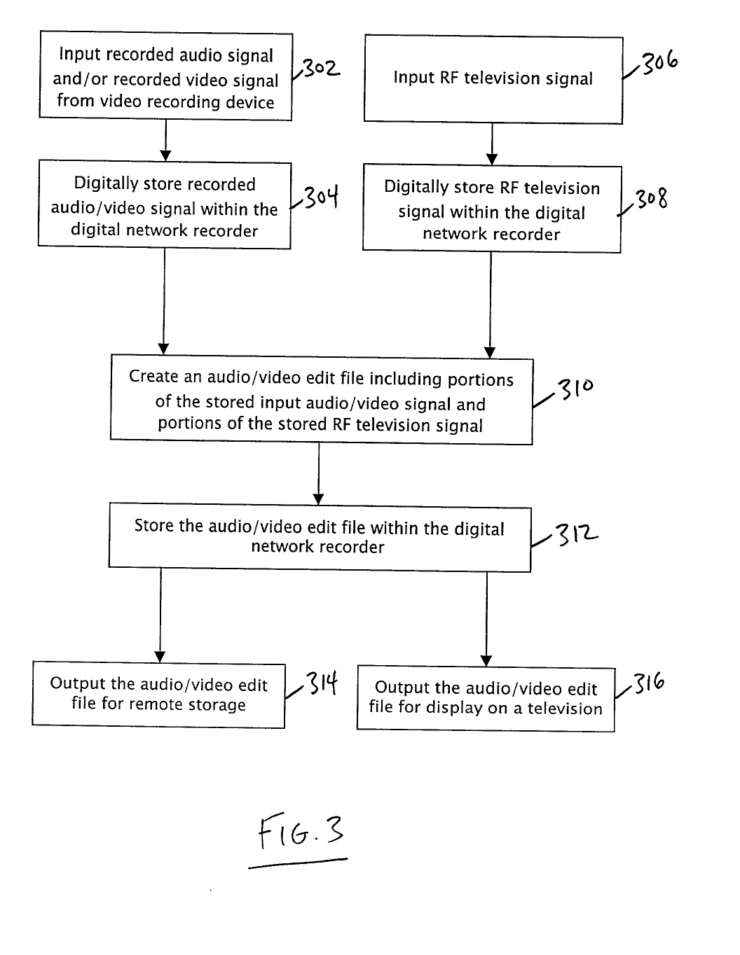

Referring next to FIG. 3, a flowchart is shown of the steps performed by the digital network recorder of FIGS. 1 and 2 while utilizing the audio/video editing software of FIG. 2. The audio/video editing software is stored on the hard drive of the digital network recorder and is loaded into RAM and executed by the processor.

A prerecorded audio and/or video signal is input from an external recording device or from an external memory (Step 302). As such, an analog or digital camcorder, a CD player, or a digital camera is coupled to the digital network recorder such that these signals are input into the digital network recorder. Next, the prerecorded audio/video signal is digitally stored within the digital network recorder (Step 304), for example, on the hard drive. If the input signal is analog, then the analog input signal is digitized by an A/D converter within the digital network recorder. Furthermore, in some embodiments, the input signal is compressed according to a compression standard (e.g., MPEG2) prior to being stored on the hard drive. In some embodiments, the compression format will be the same format as used when compressing and storing live television signals.

Also, the incoming or live television signal is input into the digital network recorder as is commonly done (Step 306). Note that Step 306 may be performed simultaneously with, after or before Steps 302 and 304, since the digital network recorder continuously records the input television signal. As is commonly done, the input television signal is digitally stored within the digital network recorder (Step 308), for example, on the hard drive. This television signal may also have to be converted to a digital signal by a corresponding A/D converter depending on the television delivery system. Furthermore, the digital television signal is compressed prior to being stored.

Next, based upon commands from the user, the audio/video editing software creates an audio/video edit file that includes portions of the stored prerecorded audio signal and/or video signal and portions of the stored input television signal (Step 310). The audio/video edit file is then stored in the digital network recorder (Step 312), for example, on the hard drive. Again the creation (Step 310) of the audio/video edit file is performed by the audio/video editing software under the command and control of the user.

A subsequent step involves outputting the audio/video edit file for remote storage (Step 314). Thus, the audio/video edit file is exported to an external storage, such as a camcorder, digital camera, VHS or memory stick. Also, the audio/video edit file may be output for display on the television attached to the digital network recorder (Step 316). The audio/video editing software controls each of these steps, in that it controls storing and retrieving the audio/video/television signals to and from the proper locations on the hard drive, both in original form and in edited form. The user is able to operate the audio/video editing software via menu displays and screen overlays that are displayed on the television. For example, the user simply uses the remote control that is designed to operate the digital network recorder. For example, the remote control is normally used to select channels, view information, rate programming content, view program scheduling, and operate the features unique to the digital network recorders, such as pausing, rewinding, fast forwarding, etc., the live television signal.

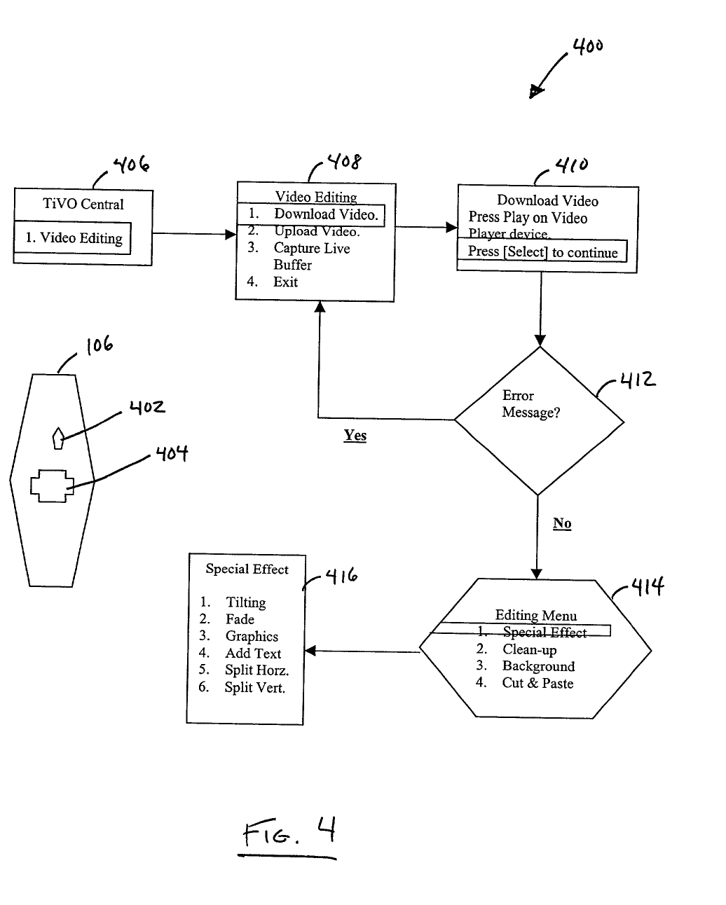

Referring next to FIG. 4, a diagram is shown of one embodiment of a user interface 400 with the audio/video editing software using a remote control 106 compatible with the digital network recorder 102. Illustrated are the remote control 106 adapted for use with the Sony SVR-2000 that uses the TiVO service. The remote control 106 includes a TiVO button 402 (also referred to generically as a “function key”) and a cursor key 404. Additionally, sample simplified screen displays 406, 408, 410, 412, 414 and 416 are illustrated. These screen displays 406, 408, 410, 412, 414 and 416 appear as graphics overlays on the television screen coupled to the digital network recorder.

Advantageously, the user operates the audio/video editing functionality of the digital network recorder using the remote control 106 to guide through various menus which will effect the creation of an audio/video edit file within the digital network recorder. The remote control 106 may operate using infrared (IR) or using radio frequency (RF). Initially, the user simply presses the TiVO button 402, which displays screen display 406 on the user's television. The user simply presses the number “1” button on the remote control 106 or highlights the desired option (e.g., “1. Video editing”) and presses either the TiVO button 402 or another button which functions similarly to an “enter” key, e.g., a “select” button or an “ok” button.

When the user selects the video editing functionality, at least a portion of the audio/video editing software is loaded from the hard drive into the RAM of the digital network recorder such that the processor may run the audio/video editing software. Next, screen display 408 appears on the television, which provides the user the options to: (1) Download video, (2) Upload Video, (3) Capture Live Buffer and (4) Exit. The user simply presses the appropriate button number or highlights the desired option with the cursor key 404 and presses the TiVO button 402 or other enter-type button.

For example, if the user selects “Download video”, screen display 410 appears on the television screen. This screen instructs the user to press play or transmit on the external video recording/player device and press the “select” button, for example. Thus, the digital network recorder is receiving an audio and/or video signal from the external device. Alternatively, the user may download a digital picture from a digital camera coupled to the digital network recorder. If there is an error or malfunction in the signal transfer, screen display 412 appears on the television, followed again by screen display 408. Alternatively, if the user selects option (3) to Capture live buffer, the user is provided the instructions to edit in portions of the input television signals that are routinely stored or buffered within the digital network recorder.

Once the external audio and/or video signal is downloaded and stored on the hard drive of the digital network recorder, an editing menu may be caused to appear on the television, e.g., screen display 414. The user will then be provided with options to: (1) add special effects, (2) clean-up, (3) add background audio and/or video, and (4) cut and paste. For example, by selecting “cut and paste” the user will have the option to edit in portions of other downloaded audio and/or video content or edit in portions of the input television signal that is recorded routinely by the digital network recorder and is stored on the hard drive. In some embodiments, by selecting the “cut and paste” option the user may be guided back to screen display 408.

If, for example, the user selects (1) add special effects, then screen display 416 is displayed on the television. This special effects menu may allow the user to add the following special effects: (1) tilting, (2) fading, (3) add graphics, (4) add text, (5) split horizontal, and (6) split vertical. It is noted that this list of special effects is not meant to be a complete listing, it is merely provided as an example of different types of special effects.

If the user wants to upload an audio/video edit file that is created, the user may navigate to screen display 408 and select option “2. Upload Video”. At this point, the user would be guided through the process of uploading the audio/video edit file for external storage or playing.

The user interface 400 of FIG. 4 is intended to be a simplified menu-driven approach to operate the audio/video editing software that is incorporated into the digital network recorder. One skilled in the art could design a virtually infinite number of possible screen displays and menus that would utilize the features of the audio/video editing software. Such audio/video editing software is generally known in the art and commercially available. Thus, further details are not provided as to more specific screen displays and menus that might be used to operate the audio/video editing software since such details are within the abilities of one skilled in the art. Additionally, the technology to create the graphics overlays to create the screen displays is also well known in the art and already exists within conventional digital network recorders. For example, conventional digital network recorders are operated using the remote control 106 and many menus to scroll through, for example, the user scrolls through programming content menus, programming rating menus, pay per view ordering menus, and VCR-like recording programming.

As such, the simplified user interface 400 is intended merely to illustrate the concept of operating the audio/video editing software via the screen menus (e.g., screen displays 406, 408, 410, 412, 414 and 416) and the remote control 106 and not to provide an exhaustive listing of the possible menus. However, such possible menus would include menus for selecting and viewing portions of the recorder input television signal to be edited along with the externally provided prerecorded audio and/or video signals. Thus, a user could select a portion of the input television signal that is stored, view it, and cut and paste portions of it into the audio/video edit file the user is creates with the aid of the audio/video editing software on the digital network recorder.

In alternative embodiments, instead of using the original remote control 106 to operate the audio/video editing functionality, a specially designed remote control may be provided that has special control buttons tailored to ease the interaction with the user. Alternatively, special audio/video related buttons may be incorporated into the housing of the digital network recorder.

Thus, the audio/video editing software as incorporated in the digital network recorder advantageously allows the user to edit and mix and match portions of one or more of the following: externally recorded audio signals (e.g., music recorded on a CD, audio that accompanies a video file); externally recorded video signals (e.g., video signals from a camcorder or DVD player or even digital still images from a digital camera); special effects, graphics, text, etc. specific to and provided by the audio/video editing software; and broadcast television signals that are recorded within the digital network recorder during its normal intended usage.

While the invention herein disclosed has been described by means of specific embodiments and applications thereof, numerous modifications and variations could be made thereto by those skilled in the art without departing from the scope of the invention set forth in the claims.

What is claimed is:

1. A digital network recorder comprising:
a digital storage device including audio/video editing software;
a television signal input coupled to the digital storage device;
a video input coupled to the digital storage device;
an audio input coupled to the digital storage device;
a processor coupled to the digital storage device; and
a television signal output coupled to the digital storage device, wherein the digital storage device stores television signals from the television signal input, audio signals from the audio input and video signals from the video input.

2. The digital network recorder of claim 1 wherein the digital storage device comprises a hard drive.

3. The digital network recorder of claim 2 further comprising a random access memory coupled to the processor.

4. The digital network recorder of claim 1 wherein the audio/video editing software enables a user to create an audio/video edit file including portions of the television signals and portions of the one or more of the audio signals and the video signals.

5. The digital network recorder of claim 1 wherein the television signal input receives live television signals broadcast from a television service provider.

6. The digital network recorder of claim 1 wherein the audio input receives recorded audio signals from an external audio source.

7. The digital network recorder of claim 1 wherein the video input receives recorder video signals from an external video source.

8. The digital network recorder of claim 1 further comprising an audio/video output for exporting the audio/video edit file to an external device.

9. The digital network recorder of claim 7 wherein the external device comprises a device selected from a group consisting of: a camcorder, an external hard drive, and a memory stick.

10. The digital network recorder of claim 1 wherein the audio input and the video input comprise a signal integrated audio/video input.

11. The digital network recorder of claim further comprising a housing, wherein the housing contains the digital storage device, the television signal input, the video input, the audio input, the processor and the television signal output.

12. The digital network recorder of claim 1 wherein the video input further comprises a digital image input for receiving digital images from a digital camera.

13. An audio/video editing system comprising:
a digital network recorder including audio/video editing software;
an input television signal coupled to a first input of the digital network recorder;
a television coupled to a first output of the digital network recorder;
an external audio/video source coupled to a second input of the digital network recorder; and
an external memory device coupled to a second output of the digital network recorder.

14. The audio/video editing system of claim 13 wherein the external audio/video source is selected from a group consisting of: a video recorder, a music player and a camera.

15. The audio/video editing system of claim 13 wherein the digital network recorder includes:
a digital storage device including the audio/video editing software;
a television signal input coupled to the digital storage device and for receiving the input television signal;
an audio/video input coupled to the digital storage device and for receiving audio/video signals from the external audio/video source;
a processor coupled to the digital storage device; and
a television signal output coupled to the digital storage device and for transmitting television signals to the television, wherein the digital storage device stores the input television signal and the audio/video signals from the external audio/video source.

16. The audio/video editing system of claim 15 wherein the audio/video editing software enables a user to create an audio/video edit file including portions of the input television signal and portions of the audio/video signals.

17. A method of audio/video editing in a digital network recorder comprising:
inputting one or more of a recorded audio signal and a recorded video signal from an external recording device into the digital network recorder;
digitally storing the one or more of the recorded audio signal and the recorded video signal within the digital network recorder;
inputting a live television signal into the digital network recorder;
digitally storing the live television signal within the digital network recorder;
creating an audio/video edit file including portions of the one or more of the recorded audio signal and the recorded video signal having been stored and portions of the live television signal having been stored; and
storing the audio/video edit file within the digital network recorder.

18. The method of claim 17 further comprising exporting the audio/video edit file for remote storage.

19. The method of claim 17 further comprising outputting the audio/video edit file for display on a television.

20. The method of claim 17 further comprising outputting the live television signal to a television.

21. The method of claim 17 wherein the recorded video signal comprises a recorded digital still image from a digital camera.
